(19) United States
(12) Patent Application Publication
(10) Pub. No.: US 2013/0221057 A1
(43) Pub. Date: Aug. 29, 2013

(54) Openable Labor-saving Stapler

(71) Applicant: Hongbo Zhao, Ninghai (CN)

(72) Inventor: Hongbo Zhao, Ninghai (CN)

(21) Appl. No.: 13/611,024

(22) Filed: Sep. 12, 2012

(30) Foreign Application Priority Data
Feb. 29, 2012 (CN) 201220070070.0

(51) Int. Cl. B25C 5/11

(52) U.S. Cl. 227/129

(57) ABSTRACT

a labor-saving stapler having a base, an anvil, a pair of frames having front gears, a staple magazine pivot to the frames, a first elastic element between the base and the staple magazine, a striker lever having a striker and middle striker openings, a second elastic element between the staple magazine and the striker lever, a pressing lever having rear gears meshable with the front gears, middle lever openings and a middle pin passing across the middle striker and lever openings. The stapler is labor-saving and credible.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a stationery stapler, and more particularly, to a stapler which is credible and efficiently labor-saving.

2. Description of Related Art

Staplers are a common used stationery. It is used to staple a pile of papers up. A conventional labor-saving stapler has a base which is able to be placed on a plane, such as a table, an anvil formed on a front end of the base, a pair of frames formed on a rear end of the base, a rear pin passing across a rear portion of the pair of frames, a top pin passing across a top portion of the pair of frames, a staple magazine having a magazine rear pivotally linked to the rear pin and a magazine front containing staples, a striker lever having a striker rear also pivotally linked to the rear pin and a striker front having a striker for pressing a staple out from the staple magazine, a hand lever having a lever rear pivotally linked either to the top pin or to the striker lever and a lever front which is able to be pressed down by a hand of a user, and a leverage provided between the striker lever and the hand lever for saving labor of the user to press down the hand lever.

However, the leverage of such stapler always has a complex structure which often out of work in actual use. Therefore it is desirable that a labor-saving having high efficiency and simple yet credible structure is provided.

### BRIEF SUMMARY OF THE INVENTION

The main object of the invention is to provide an openable labor-saving stapler having credibility and a high labor efficiency.

In order to accomplish the above objects, the present invention provides an openable labor-saving stapler having a base, an anvil formed on a front end of the base, a pair of frames being formed on a rear end of the base and each having a rear hole and a front gear, a rear pin passing across the rear holes on the pair of frames, a staple magazine having a magazine rear pivotally linked to the rear pin and a magazine front, a first elastic element between the base and the staple magazine, a striker lever having a striker rear pivotally linked to the rear pin, a striker front having a striker, and a pair of middle striker openings defined therein, a second elastic element between the staple magazine and the striker lever, and, a pressing lever having a lever front, a pair of rear gears each being meshable with one of the front gears, a pair of middle lever openings defined therein, a middle pin passing across the middle striker openings in the striker lever and the middle lever openings in the pressing lever, a third elastic element between the striker lever and the pressing lever, and, a hand cover pivotally linked to the rear pin.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a perspective schematic view of a preferred embodiment of an openable labor-saving stapler of the invention.

FIG. 2 is an exploded perspective view of the openable labor-saving stapler shown in FIG. 1.

FIG. 3 is a perspective view of a hand cover of the openable labor-saving stapler shown in FIG. 1.

FIG. 4 is a partially side plane view of the openable labor-saving stapler shown in FIG. 1. And,

FIG. 5 is a side plane view of the openable labor-saving stapler shown in FIG. 1 in a status of being opened.

### DETAILED DESCRIPTION OF THE INVENTION

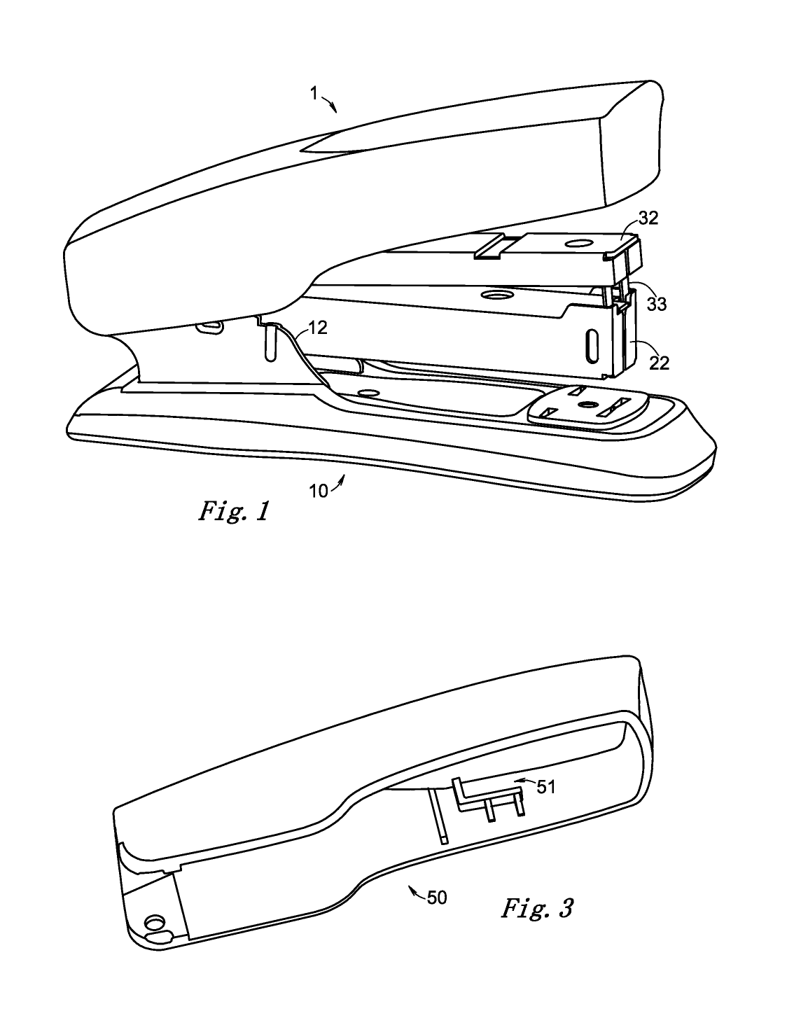

With reference to FIGS. 1, 2, 3, 4 and 5, a labor-saving stapler 1 of the invention is shown. The labor-saving 1 has a base 10 which is able to be placed on a plane, such as a table, an anvil 11 formed on a front end of the base 10, a pair of frames 12 being formed on a rear end of the base 10 and each having a rear hole 13 and a front gear 14, a rear pin 15 passing across the rear holes 13 on the pair of frames 12, a staple magazine 20 having a magazine rear 21 pivotally linked to the rear pin 15 and a magazine front 22 containing staples (not shown in the Figs.), a first elastic element 23 between the base 10 and the staple magazine 20, a striker lever 30 having a striker rear 31 also pivotally linked to the rear pin 15, a striker front 32 having a striker 33 for pressing one staple out from the staple magazine 20, and a pair of middle striker openings 34 defined therein, a second elastic element 35 between the staple magazine 20 and the striker lever 30, a pressing lever 40 having a lever front 41, a pair of rear gears 42 each being meshable with one of the front gears 14 on the frames 12, a pair of middle lever openings 43 defined therein, a middle pin 44 passing across the middle striker openings 34 in the striker lever 30 and the middle lever openings 43 in the pressing lever 40, a pair of front lever openings 45 defined therein, a front pin 46 passing across the pair of front lever openings 45, and a pair of square sliders 47 covering on the front pin 46, a third elastic element 48 between the striker lever 30 and the pressing lever 40, and a hand cover 50 pivotally linked to the rear pin 15 and having a pair of inner grooves 51 for respectively containing the pair of square sliders 47 therein.

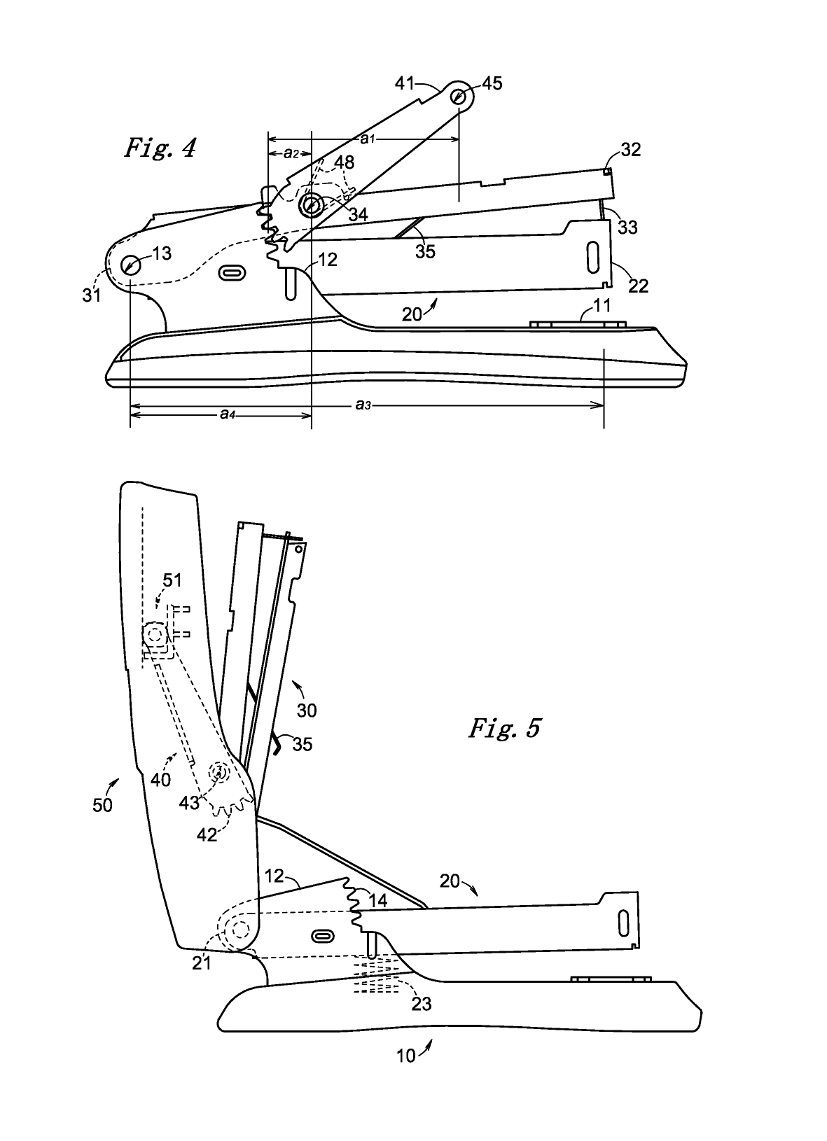

In use, the labor-saving stapler 1 of the invention is in a spare status as shown in FIGS. 1 and 4, in which the first, the second and the third elastic elements 23, 34 and 48 are fully expanded. The user is able to place a pile of papers need to be stapled between the magazine front 22 and the anvil 11 and then press down the hand cover 50. The hand cover 50 will rotate round the rear pin 15 and the inner grooves 51 will press the square sliders 47 downward. The square sliders 47 are driven to move downward and at the same time, slide forward along the inner grooves 51. As the square sliders 47 move downward, the lever front 41 of the hand lever 40 rotate round the middle pin 44 against the first, the second and the third elastic elements 23, 34 and 48. Simultaneously, the rear gears 42 rotate round the front gears 14 like a planetary gear and go downward. As the rear gears 42 rotates downward, the middle pin 44 will urge the striker lever 30 move downward to staple. After the stapling, the user is able to release the hand lever 40 and the first, the second and the third elastic elements 23, 34 and 48 will respectively urge the staple magazine 20, the striker lever 30 and the pressing lever 40 back to the spare status. If staples need to be reloaded to the staple magazine 20, the user is able to pull the hand cover 50 upward and the rear gear 42 will leave and disengage with the front gear 14 and the striker lever 30 will be able to be lifted for reloading staples, as shown in FIG. 5. The striker lever 30, the staple magazine 20, and their relation to staple reloading are conventional skills and will not described here in detail.

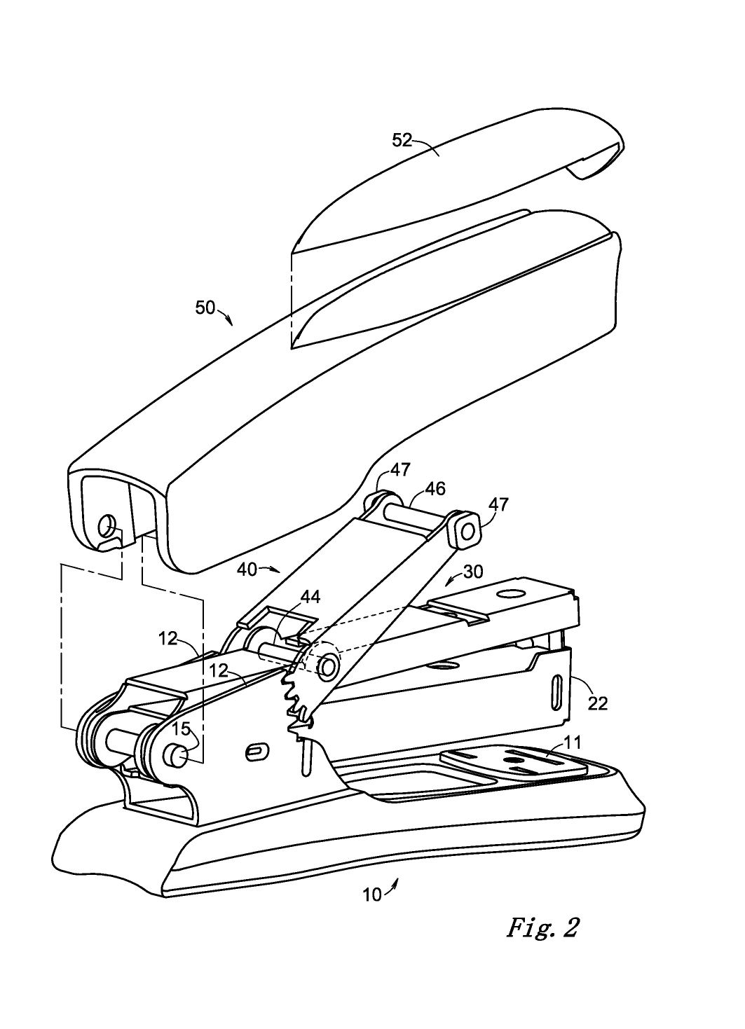

As especially shown in FIG. 4, an arm of a hand pressing force al is usually 7-10 times of an arm of a rear gears' 42 reaction force a2, and an arm of a stapling resistance a3 is usually 3 times of an arm of a middle pin's 43 pressing force a4. Therefore, a leverage effect of the labor-saving stapler is able to about 7/3-10/3 times. From above description, it could be seen that the labor-saving stapler has a high labor efficiency and at the same time, has a simple structure which is much more credible. As especially shown in FIG. 2, a rubber pad 52 may be provided on the hand cover 50 for better feeling of touch of user's hand.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. An openable labor-saving stapler comprising:
a base,
an anvil formed on a front end of the base,
a pair of frames being formed on a rear end of the base and each having a rear hole and a front gear,
a rear pin passing across the rear holes on the pair of frames,
a staple magazine having a magazine rear pivotally linked to the rear pin and a magazine front,
a first elastic element between the base and the staple magazine,
a striker lever having a striker rear pivotally linked to the rear pin, a striker front having a striker, and a pair of middle striker openings defined therein,
a second elastic element between the staple magazine and the striker lever,
a pressing lever having a lever front, a pair of rear gears each being meshable with one of the front gears, a pair of middle lever openings defined therein, a middle pin passing across the middle striker openings in the striker lever and the middle lever openings in the pressing lever,
a third elastic element between the striker lever and the pressing lever, and,
a hand cover pivotally linked to the rear pin.

2. The openable labor-saving stapler as claimed in claim 1, wherein the pressing lever further has a pair of front lever openings defined therein, a front pin passing across the pair of front lever openings, and a pair of square sliders covering on the front pin, and the hand cover further has a pair of inner grooves for respectively containing the pair of square sliders therein.
